(19) United States
(12) Patent Application Publication
(10) Pub. No.: US 2026/0057450 A1
(43) Pub. Date: Feb. 26, 2026

(54) SYSTEMS AND METHOD FOR GENERATION OF FINANCIAL SUMMARY INTERFACES

(71) Applicant: Royal Bank of Canada, Toronto (CA)

(72) Inventors: Joseph NEGEDE, Toronto (CA); Raoof NAUSHAD, Toronto (CA); Om PATEL, Toronto (CA); Nandhakishore Krishnamurthy Shanthi, Toronto (CA)

(21) Appl. No.: 19/305,883

(22) Filed: Aug. 21, 2025

Related U.S. Application Data
(60) Provisional application No. 63/685,402, filed on Aug. 21, 2024.

(51) Int. Cl. G06Q 40/06

(52) U.S. Cl. CPC G06Q 40/064

(57) ABSTRACT

Periodic bank statements may be created that are dynamic and interactive. Financial transactions of users can be ingested and similar users clustered together. The financial transactions of users can be displayed and additional insights generated using a large language model.

### RELATED APPLICATIONS

The current application claims priority to U.S. Provisional Patent Application 63/685,402 entitled “Systems and Method for Generation of Financial Summary Interfaces,” filed Aug. 21, 2024, the entire contents of which are incorporated herein by reference for all purposes.

### TECHNICAL FIELD

The current disclosure relates to a providing an interface for a user's financial summary, and in particular to systems and method for providing financial summaries using a large language model (LLM).

### BACKGROUND

Banking statements are provided as a static document, such as a PDF, providing a summary of a user's financial transactions for a period of time, typically a month. While online accounts can provide up-to-date information about user's accounts, including details of the latest transaction, they provide little additional information beyond transaction information.

An additional, alternative, and/or improved process for providing financial summary information to users is desirable.

### SUMMARY

In accordance with the present disclosure there is further described a system for use in generating a financial summary interface, the system comprising: at least one processor for executing instructions; and at least one memory storing instructions which when executed by one or more of the at least one processor configure the system to provide: a data ingestion component for periodically ingesting financial transaction data and user profile data and storing in a contextual datastore; a financial analysis component for generating at least one graphical representation of financial information associated with a user stored in the contextual datastore; a contextual chat component for responding to user chat queries using a large language model (LLM) and the financial information associated with a user stored in the contextual datastore; a financial insight component for generating one or more financial insights using the LLM and the financial information associated with the user stored in the contextual datastore; and a large language model (LLM) interface for interfacing with an LLM.

In a further embodiment of the system, the financial transaction data and user profile data is processed in order to group similar users together.

In a further embodiment of the system, users are grouped together based on one or more of: age; geographic location; and financial life stage.

In a further embodiment of the system, the contextual chat component uses a TXT to SQL LLM to generate a SQL query for use in retrieving data for use in responding to the user query.

In a further embodiment of the system, the response is generated by a response synthesis LLM and includes an indication of whether the response includes a visualization.

In a further embodiment of the system, the contextual chat component generates a response synthesis prompt based on the user query and the contextual data from the SQL query, the response synthesis prompt provided to the LLM to generate a response that includes response text and an indication of whether the response includes a visualization, and when the response includes a visualization the visualization data for use in generating the visualization.

In a further embodiment of the system, the prompt is further generated using one or more of: a table schema and feature description of financial information; and a conversation history of the user's chat.

In a further embodiment of the system, the financial analysis component includes one or more of: a financial overview component; a spending analysis component; and a comparative analysis component.

In a further embodiment of the system, the financial insight component comprises one or more of: a scenario insight component; and a budget insight component.

In a further embodiment of the system, the financial insight component includes one or more context generators for retrieve contextual data for use in generating the financial insights.

In a further embodiment of the system, the context generators comprise one or more of: a Financial Summary generator; a Savings and Investments generator; a Debts & Mortgages generator; a Bank Fees generator; a Top Spending Categories (Current Month) generator; a Top Spending Categories (Last 6 Months) generator; a Top Spending Merchants (Current Month) generator; a Top Spending Merchants (Last 6 Months) generator; a User Spending Summary generator; and a Similar People Spending Summary generator.

In a further embodiment of the system, the financial insight component comprises a prompt generator to generate prompts to the LLM to generate the financial insights.

In a further embodiment of the system, the prompt generator generates the prompts using pre-planned structure for generating the prompts.

In a further embodiment of the system, the prompt generator uses the context generators to fetch necessary data for use in pre-defined LLM prompt templates designed with Chain of Thought and Few Shot Prompting techniques.

In a further embodiment of the system, the LLM prompt templates are further designed using guardrails.

In accordance with the present disclosure there is further described a method for use in generating a financial summary interface, the method comprising: periodically ingesting financial transaction data and user profile data and storing in a contextual datastore; generating at least one graphical representation of financial information associated with a user stored in the contextual datastore; receiving a user chat query and responding to the user chat query using a large language model (LLM) and the financial information associated with a user stored in the contextual datastore; and generating one or more financial insights using the LLM and the financial information associated with the user stored in the contextual datastore.

In a further embodiment of the method, the financial transaction data and user profile data is processed in order to group similar users together.

In a further embodiment of the method, users are grouped together based on one or more of: age; geographic location; and financial life stage.

In a further embodiment of the method, the responding to the user chat query uses a TXT to SQL LLM to generate a SQL query for use in retrieving contextual data from the financial information associated with the user stored in the contextual datastore for use in responding to the user query.

In a further embodiment of the method, the response to the user query is generated from a response synthesis prompt based on the user query and the contextual data from the SQL query, the response synthesis prompt provided to the LLM to generate a response that includes response text and an indication of whether the response includes a visualization, and when the response includes a visualization the visualization data for use in generating the visualization.

In a further embodiment of the method, the method further comprises generating a prompt for the TXT to SQL LLM using the user query.

In a further embodiment of the method, the prompt is further generated using one or more of: a table schema and feature description of financial information; and a conversation history of the user's chat.

In a further embodiment of the method, the financial insights are generated using one or more context generators for retrieving contextual data for use in generating the financial insights.

In a further embodiment of the method, the context generators comprise one or more of: a Financial Summary generator; a Savings and

Investments generator; a Debts & Mortgages generator; a Bank Fees generator; a Top Spending Categories (Current Month) generator; a Top Spending Categories (Last 6 Months) generator; a Top Spending Merchants (Current Month) generator; a Top Spending Merchants (Last 6 Months) generator; a User Spending Summary generator; and a Similar People Spending Summary generator.

In a further embodiment of the method, a prompt generator to generates prompts to the LLM to generate the financial insights.

In a further embodiment of the method, the prompt generator generates the prompts using pre-planned structure for generating the prompts.

In a further embodiment of the method, the prompt generator uses the context generators to fetch necessary data for use in pre-defined LLM prompt templates designed with Chain of Thought and Few Shot Prompting techniques.

In a further embodiment of the method, the LLM prompt templates are further designed using guardrails.

In accordance with the present disclosure there is further described a non-transitory computer readable medium storing instructions thereon, which when executed by a system configure the system to perform any of the methods described above.

### BRIEF DESCRIPTION OF THE DRAWINGS

Further features and advantages of the present disclosure will become apparent from the following detailed description, taken in combination with the appended drawings, in which:

FIG. 1 depicts a system including enhanced financial statement functionality;

FIG. 2 depicts components of the enhanced financial statement functionality;

FIG. 3 depicts a process flow for contextual chat;

FIG. 4 depicts components for providing scenario insights and budget insights; and

FIGS. 5A-7B depict graphical user interfaces.

### DETAILED DESCRIPTION

A financial analytics and visualization tool is described further below that provides an improved financial statement or financial summary interface. This tool can provide a financial dashboard providing graphical representations of financial information as well as a recommendation engine that can provide insights into a user's finances using advanced generative AI models and techniques like Retrieval Augmented Generation and Chain of thoughts prompting.

The financial summary interface aims to enhance the conventional e-statement experience by transforming static monthly financial summaries into dynamic, interactive insights. The traditional e-statements, typically delivered as PDF documents via email, through a website or mobile banking app, often fail to provide meaningful engagement for users due to their static nature. The financial summary interface addresses this challenge by offering an interactive financial summary that not only informs users about their financial activities but also empowers them to make better financial decisions. Additionally, it adds flexibility for users to explore and understand specific aspects of their financial data according to their needs, helping them realize simple strategies and their potential impacts on their finances.

The financial analytics and visualization tool can generate an interactive interface that provides a comprehensive financial report available to clients with periodically updated information, such as at the beginning of each month. This interactive interface provides an engaging and informative financial story through accessible data dashboards. The data dashboards can provide a graphical representation of user's financial data. The interactive dashboards simplifies the understanding of the client's financial journey over the last month, or other time periods.

The dashboards may include a financial overview that provides a high-level summary of the client's financial activities for the month, or other periods of time. The financial overview dashboard can present key metrics such as net balance, bank fees, total spending, and total income, which may all be compared to the previous month, or other time periods. The financial overview dashboard may further include a daily balance tracker for the current and previous months, highlighting peak balance periods.

The dashboards may further comprise a spending analysis dashboard that provides detailed insights into the client's spending patterns. This dashboard categorizes spending, identifies spending locations, and lists top merchants, all compared to the previous month. It offers clients a deeper understanding of their spending habits.

The dashboards may further comprise a comparative analysis dashboard that compares the client's financial behavior with that the financial behavior of similar clients. The comparative analysis dashboard may utilize a clustering technique based on fields in the client profile to identify similar clients. This dashboard allows clients to compare their spending against similar clients, and their own historical data over the past six months or other time periods. This comparative analysis dashboard can help clients identify areas for potential budgeting and financial improvement. Further, the tool can automatically identify and suggest budgeting adjustments based on the client's spending patterns compared to similar clients. This can be achieved through Generative AI, RAG techniques, and client clustering. The client clustering groups clients based on, for example, geographical location, age group, and financial level using existing data. Other techniques for identifying comparably clients to the user may be used.

In addition to the data dashboards, the financial analytics and visualization tool can also provide insight into the client's summary data using automated chat functionality. The chat functionality can provide clients with personalized financial insights through natural language queries. The chat functionality may also generate visual representations for use in answers to the client's queries. Clients can interact with the chat system, which may use AI systems or components, by asking questions in natural language about their spending and financial activities. The system is context aware and conversational aware. The system can generate responses based on transaction data and, if applicable, can include dynamically generated visualizations to enhance the client's understanding. The interactive chat functionality enables users to interact with their financial data using natural language. The AI system, equipped with context from the user's transaction history via Retrieval-Augmented Generation (RAG) techniques, can provides relevant and accurate responses. The chat functionality may also provide users with dynamically generated visualizations based on their queries. The AI determines the necessity of visual representation and creates visuals using Generative AI models, and RAG techniques. Using the chat functionality, users can query specific information and receive instant, context-aware responses. The on-the-fly visualization further enhances understanding, surpassing the capabilities of current banking app chatbots, which lack context awareness, conversation tracking and visualization functionality.

The tool may provide additional functionality for providing insights into the client's finances. The tool can provide additional insights and hypothetical scenarios to clients based on their financial data. This will help the user to see the results of their actions even before taking the actions. “What If?” analysis can present hypothetical scenarios to show clients how different financial decisions may impact their finances. The what if analysis offers users the ability to explore hypothetical scenarios and their potential impacts on their financial situation. Generative AI models, leveraging context from function tools, and prompt engineering, generate these strategic insights. This can help the user to take actions for a better financial well-being. The insights may be generated using pre-generated plan of action-based framework structures. The functionality can retrieve the relevant transactional data to populate prompts used to generate insights. Techniques such as Chain of Thought and Few Shot Prompting may be used to provide high accuracy and relevance in the generated insights, including what-if analyses, spending insights, and budgeting suggestions.

The tool described herein improves traditional e-statements, transforming static financial summaries into dynamic, interactive experiences. By leveraging AI models and data visualization techniques, it provides clients with actionable insights, personalized recommendations, and a deeper understanding of their financial health.

The financial analytics and visualization tool uses various AI techniques for providing the functionality described above, including Retrieval-Augmented Generation (RAG), Pre-Planned Structure Framework, Chain of Thought Prompting, and Few Shots Prompting. Retrieval-Augmented Generation (RAG) combines retrieval-based and generation-based methods to enhance the accuracy and relevance of AI responses. RAG is used in both the context-aware chat feature and the generation of spending insights. A Text-to-SQL approach may be used for Retrieval Augmented Generation for the chat feature. Pre-Planned Structure Framework utilizes a pre-planned structure for generating insights. The process involves predefined functions that fetch necessary data, which are then used in LLM prompts designed with Chain of Thought and Few Shot Prompting techniques. This approach ensures structured and efficient generation of insights based on the requirement. Chain of Thought Prompting is prompt technique that guides the AI model through a logical sequence of steps to improve reasoning and decision-making. This method is employed in generating what-if analyses and other complex insights. Few Shots Prompting enhances the AI's performance by providing a few examples of the desired output. This technique is used to fine-tune responses and improve the accuracy of generated insights.

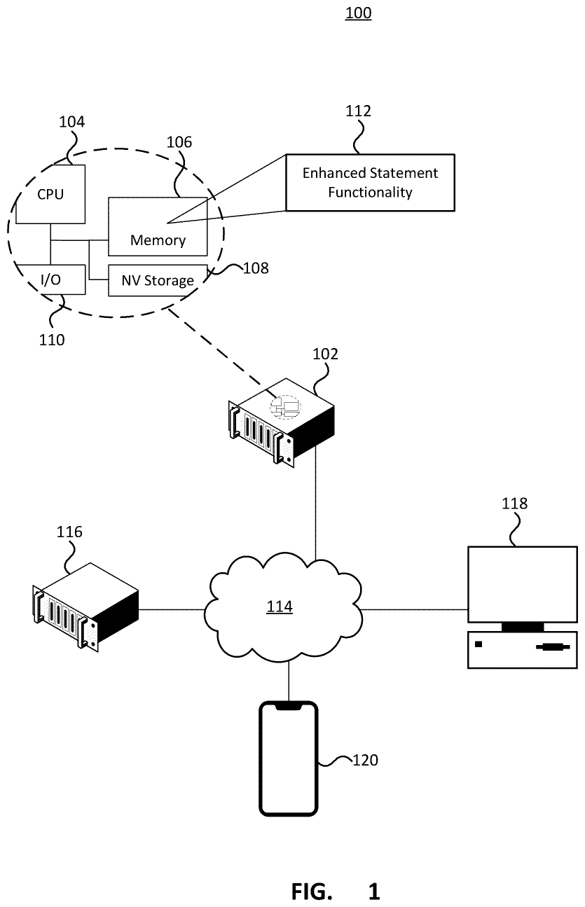

FIG. 1 depicts a system including enhanced financial statement functionality. The system includes at least one server or computing device 102. The server 102 may contain one or more processors or microprocessors, such as a central processing unit (CPU) 104. The CPU performs arithmetic calculations and control functions to execute software stored in a non-transitory internal memory 106, preferably random access memory (RAM) and/or read only memory (ROM), and possibly additional memory 108. The additional memory is non-volatile may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory may be physically internal to the computer system, or both.

The one or more processors or microprocessors may comprise any suitable processing unit such as an artificial intelligence accelerator, programmable logic controller, a microcontroller (which comprises both a processing unit and a non-transitory computer readable medium), AI accelerator, system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

The computer system may also include other similar means for allowing computer programs or other instructions to be loaded. Such means can include, for example, a communications interface (not shown) which allows software and data to be transferred between the computer system and external systems and networks. Examples of communications interface can include a modem, a network interface such as an Ethernet card, a wireless communication interface, or a serial or parallel communications port. Software and data transferred via communications interface are in the form of signals which can be electronic, acoustic, electromagnetic, optical or other signals capable of being received by communications interface. Multiple interfaces, of course, can be provided on a single computer system.

Input and output to and from the computer system may be administered by the input/output (I/O) interface 110. The I/O interface may administer control of the display, keyboard, external devices and other such components of the computer system. The computer system may also include a graphical processing unit (GPU). The GPU may also be used for computational purposes as an adjunct to, or instead of, the (CPU), for mathematical calculations.

The various components of the computer system may be coupled to one another either directly or by coupling to suitable buses. The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

The memory may store instructions which when executed by the processor, and possibly the GPU, configure the system to provide various functionality including enhanced statement functionality 112. The enhanced statement functionality 112 is depicted as being implemented by server 102. The enhanced statement may include functionality on other computing devices. For example one or more servers may implement one or more AI models used by the enhanced statement functionality. Additionally, functionality on one or more devices such as a mobile device may provide a front end interface providing a convenient means for user's to interact with the enhanced statement functionality.

The functionality 112 is depicted as being provided by a single computing system 102, however, it will be appreciated that the functionality may be provided across one or more computing systems that are communicatively coupled with each other, either directly or indirectly. The system 100 may include one or more communication networks 114 coupling additional computing devices 116, 118, 120 together. The additional computing devices may include computing devices such as servers 116 as well as one or more personal computers 118 and/or mobile devices 120 that provide various functionality. The additional computing devices 116, 118, 120 may include additional computing devices not depicted in FIG. 1, such as laptop computers, mobile phones, tablets, etc. The additional computing devices 116, 118, 120 may be computing devices on an internal network or may be accessible through one or more external networks.

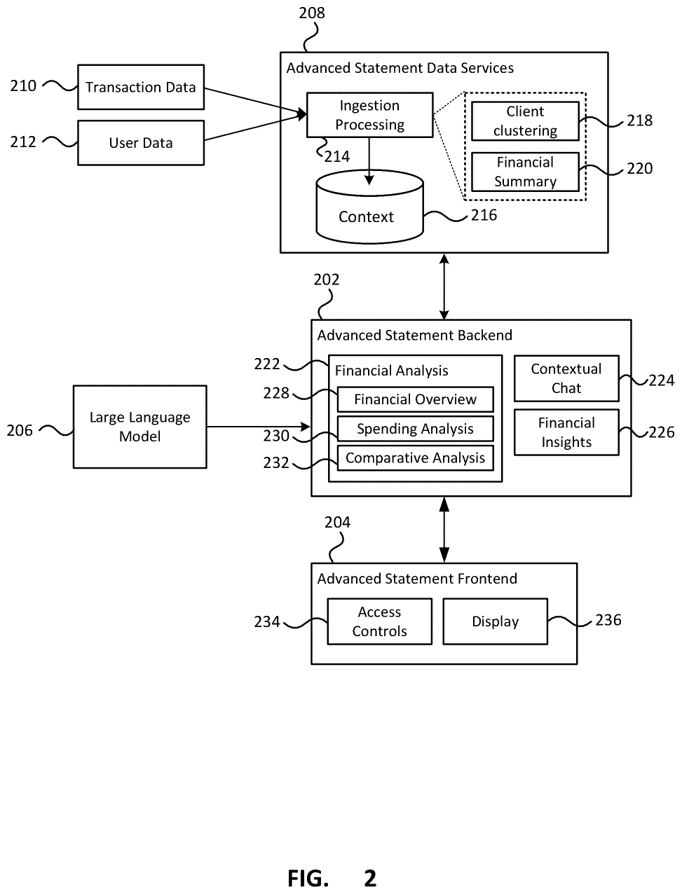

FIG. 2 depicts components of the enhanced financial statement functionality. The enhanced statement system is designed with a robust architecture that integrates various advanced technologies to provide dynamic, interactive financial insights.

The functionality depicted in FIG. 2 may be implemented by one or more computing devices, such as those depicted in FIG. 1. The functionality includes an advanced statement backend functionality 202 that works in conjunction with advanced statement frontend functionality 204. As described in further detail below, the backend functionality interacts with one or more AI models, which may be for example a large language model (LLM) 206. Various LLMs may be used such as GPT-4-Turbo provided by OpenAIR. The backend functionality 202 receives data for generating the advanced statement from advanced statement data services functionality 208.

The data services 208 can ingest transactional data 210 and user data 212 for subsequent use by the backend functionality. The data services functionality includes ingestion processing functionality 214 that receives the transactional data 210 and user data 212, processes the data and stores the data in a contextual datastore 216. The ingestion processing functionality 214 may include clustering functionality 218 that can cluster different clients into similar client groups. Clients can be clustered based on age, geographic location, and financial life stage using various clustering techniques. The client groups resulting from the clustering can be stored in the contextual datastore 216. The ingestion functionality may further include financial summary functionality 220 that can provide summaries of a user's financial data. The ingestion functionality may further include additional functionality such as functionality for categorizing transactions as well as other functionality. The data ingestion may be scheduled to periodically ingest the data. For example, the ingestion can be scheduled to run once a month, or other time periods, to aggregate transactional data, user's universal client profile data, and generate client clustering information which can be stored in the contextual datastore. The ingested contextual data can be used by the backend functionality to generate all required dashboards, visualizations and other dynamic interactive functionality.

The backend handles, in conjunction with the data services functionality, data processing and storage, as well as handling the interaction with the frontend functionality and LLM. It provides routes for saving and serving data, insights, chat interactions, and visualizations. The backend may include financial analysis functionality 222 for analyzing client transaction data. Additionally, the backend may provide additional functionality including contextual chat functionality 224 providing interactive chat and visualization functionality for investigating a client's finances as well as financial insight functionality 226 for providing additional, automated, insights to the client. The analysis functionality may include financial overview functionality 228, spending analysis functionality 230 and comparative analysis functionality 232.

The frontend functionality 204 may include access controls 234 for ensuring secure access to the client's financial information as well as securing and encrypting communications between the frontend and backend to ensure the client's sensitive financial information is not compromised. The frontend functionality may also include display functionality for displaying the data provided by the backend. The frontend is responsible for displaying the interactive dashboards, handling user interactions, and visualizing financial data. It may present the data from the backend using various dashboards, such as Overview, Spending, and Comparison dashboards.

While a particular arrangement of different functionality is depicted in FIG. 2 with some functionality implemented at the backend, frontend, data services, etc. it is possible to implement different parts of the functionality at different locations.

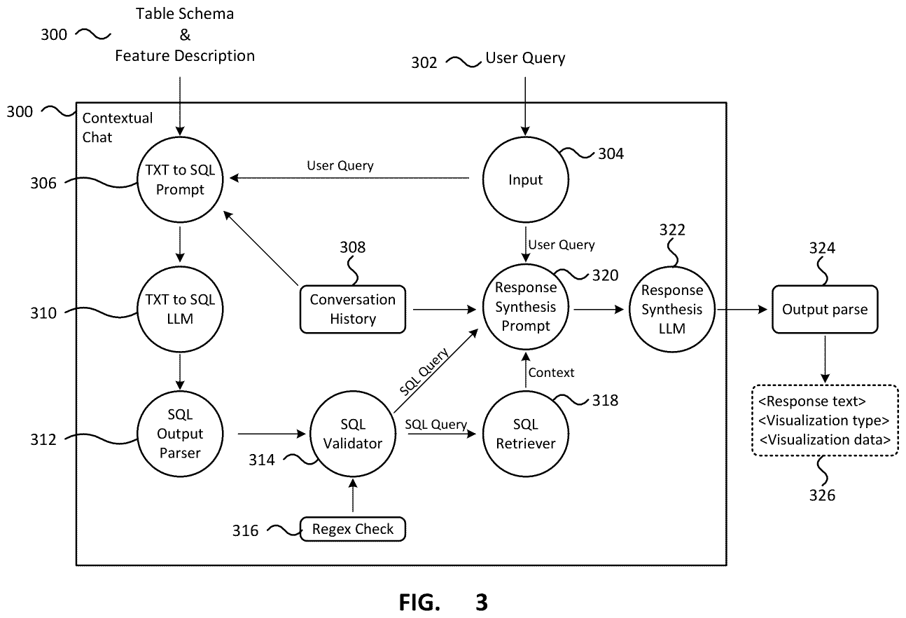

FIG. 3 depicts a process flow for contextual chat with on-the-fly visualization. The chat functionality receives user queries in natural language. Queries are converted to SQL using generative AI models, such as OpenAI GPT-4-Turbo. To achieve conversion, the database schema and information about all the necessary fields is provided to the AI model via prompting. The resulting SQL queries can be executed on the contextual datastore, and the retrieved data processed. The AI model may also determine whether a visualization is suitable for the response. If a visualization is appropriate, the data for the visualization can be formatted accordingly in the response to allow the visualization to be generated. The processed data and any required visualizations are sent back to the frontend for display.

The chat functionality efficiently processes user queries by generating and validating SQL queries, retrieving data, and synthesizing responses using advanced AI techniques. This ensures accurate and context-aware responses, enhancing the user's financial insight experience.

The process begins when a user submits a query 302 through the chat interface. This query is received by an input component 304 of the chat functionality. The input query is passed to a Text-to-SQL Prompt component 306. This prompt generation utilizes Chain of Thought and Few Shot Prompting techniques to create a well-structured query. The table schema and relevant field information, including conversation history 308, are incorporated into the prompt, while Personally Identifiable Information (PII) is masked to ensure privacy. The generated prompt is then sent to the Text to SQL LLM 310 such as GPT-4 Turbo, and the output from the LLM is sent to a SQL output parser 312 to generate an SQL query. The LLM processes the prompt and returns a response in JSON format. The response contains the generated SQL query or indicates if the query is not applicable. For example, the JSON response may be {“sql”: “<generated sql query>”} or {“sql”: “Not Applicable”}.

The JSON response is parsed by the SQL Output Parser component 312, which extracts and cleans the SQL query. The parsed SQL query can be validated by a SQL Validator component 314. This validation can involve two key checks including an applicability check that ensures the query is valid and applicable, as indicated by the LLM response. A Regex check 316 ensures no unauthorized client information is queried and replaces masked PII with original values.

Upon successful validation, the query is executed by the SQL Retriever component 318. The SQL Retriever runs the query on the PostgreSQL database and retrieves the required data. The retrieved data, along with the original user query and conversation history 308, is passed to the Response Synthesis Prompt component 320. This component synthesizes the response using context from the SQL Retriever 318 and the original query 304. The response synthesis involves another LLM call 322 to generate a detailed response in JSON format, which includes the response message in text, the type of visualization, if applicable, and data for the visualization, if applicable. The final JSON response is parsed by the Output Parser component 324. The structured response 326, including the message and any visualizations, is sent back to the frontend for display to the user.

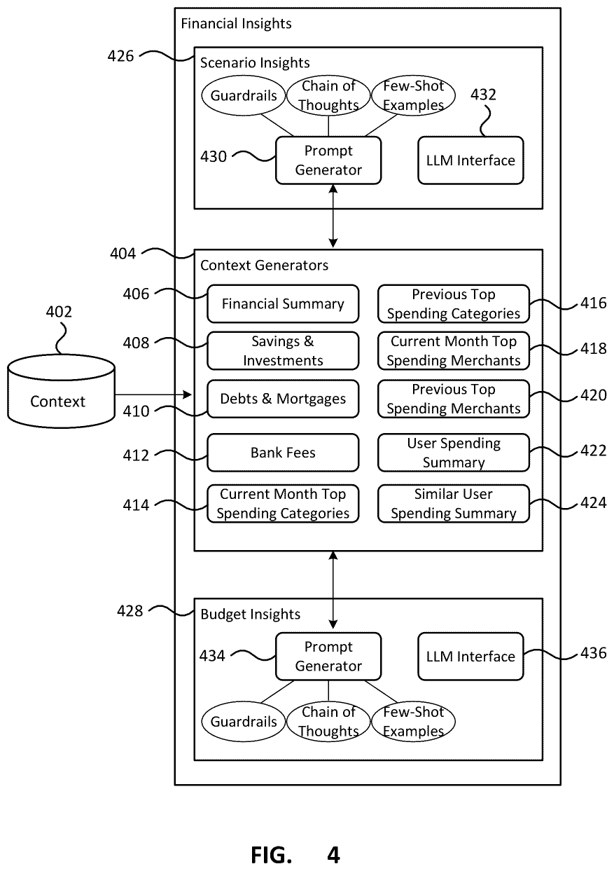

FIG. 4 depicts components for providing scenario insights and budget insights. The enhanced statement functionality may include two primary engines for generating insights: scenario insights, or “what if” insights and budget insights. Both insight components operate similarly, leveraging advanced AI techniques and predefined functions to provide personalized and impactful financial insights to clients in an efficient manner. Below is a detailed explanation of the algorithm flow for each engine.

At the end of each month or other time period, scheduled functionality can run to initiate the insight generation process. The process begins with querying the context datastore 402 to retrieve the list of client IDs for whom insights should be generated. For each of the identified clients, a number of different context generators can 404 can be run in order to generate the required context for the insights. The context generators may comprise different pre-defined functions that are used to generate the context. The generators include:
A Financial Summary generator 406 that provides an overall financial summary, including net balance, cash in, and cash out for the month compared to the previous month.
A Savings and Investments generator 408 that summarizes transactions related to savings and investments.
A Debts & Mortgages generator 410 that summarizes transactions related to debts and mortgages.
A Bank Fees generator 412 that Summarizes transactions related to bank fees.
A Top Spending Categories (Current Month) generator 414 that lists the top spending categories for the current month and compares them to the previous month.
A Top Spending Categories (Last 6 Months) generator 416 that lists the top spending categories for the last six months.
A Top Spending Merchants (Current Month) generator 418 that lists the top spending merchants for the current month and compares them to the previous month.
A Top Spending Merchants (Last 6 Months) generator 420 that lists the top spending merchants for the last six months.
A User Spending Summary generator 422 that provides the user's spending summary for each category over the last three months.
A Similar People Spending Summary generator 424 that provides the mean, maximum, and average spending for different categories among similar clients over the last six months.

The above generators can provide the needed context for different insights. Both the scenario insights 426 and the budget insights 428 operate in a similar manner, although each insight generation may require different contextual data provided by the various context generators. For example, the scenario insights may be generated using the Financial Summary generator 406, the Savings and Investments generator 408, the Debts & Mortgages generator 410, the Bank Fees generator 412, the Top Spending Categories (Current Month) generator 414, the Top Spending Categories (Last 6 Months) generator 416, the Top Spending Merchants (Current Month) generator 418, and the Top Spending Merchants (Last 6 Months) generator 420. The budget insights may be generated using the User Spending Summary generator 422 and the Similar People Spending Summary generator 424.

As depicted the scenario insight functionality may have a prompt generator component 430 that retrieves the needed information from the context generators. The generated context is passed to the Prompt Generator, which uses pre-defined prompts with guardrails, Chain of Thought techniques, and few-shot examples. The Prompt Generator populates a pre-planned structured prompt using the generated context. The structured prompt is sent to a LLM, such as GPT-4 Turbo, for processing via an LLM interface 432. The LLM returns a response in JSON format, which is then parsed by the Output Parser. Few-shot prompting techniques ensure the LLM follows the desired structure. The generated response may contain the following fields:
Scenario: Describes the personalized What If scenario.
Insight: Details the impact of the What If scenario.
Description: Provides a detailed explanation of how the insight was calculated.
Long-Term Impact: Includes a JSON object for visualizing the long-term impact of the suggested scenario.

The budget insights 428 process is similar to the scenario insights described above, although the context provided by the generators differs as well as the guardrails, chain of thoughts and few-shot examples used for the prompt generation. Client IDs of clients for which budget insights are to be generated are determined, and for each of the clients, two context generators are used to obtain the required context data for generating the insight. The generators include the User Spending Summary generator and the Similar People Spending Summary generator. The context generated is passed to the Prompt Generator 434, which uses specific prompts tailored for budget insights, incorporating guardrails and few-shot examples. The structured prompt can be sent to an LLM, such as GPT-4 Turbo, via an LLM interface 436 for processing. The LLM returns a response in JSON format, that can be parsed by an Output Parser. Few-shot prompting techniques ensure the LLM adheres to the required structure. The response may include the following fields:
Insight: Details what needs to be budgeted and the recommended amount.
Description: Explains the impact of the suggested budget and how it was calculated.
Suggested Budget: Specifies the suggested budget for each category.
Relevance: Describes the relevance of the suggested budget.

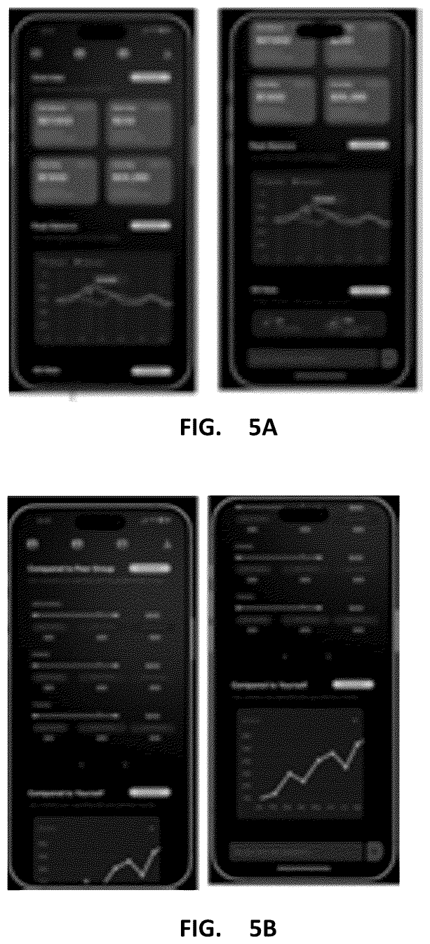

The generated insights may then be returned for display to the client at the front end. FIGS. 5A-7B depict illustrative graphical user interfaces that may be used to display the enhanced financial statement to the user. The interface depicted in FIGS. 5A-7B are shown as being an app on a mobile phone, however, other user interfaces may be provided such as a website, etc. The interfaces depicted in FIGS. 5A-7B may be part of an existing mobile banking app or may be provided as a separate enhanced financial statement app. The user may navigate to an initial landing or home page of the enhanced statement functionality. If it is the user's first time accessing the enhanced statement, the features of the interface may be demonstrated to the user including details on how to access the various features. The user may navigate to a financial dashboard depicted in FIG. 5A which provides an overview of the financial analysis and personalized insights. The user may navigate to a comparison dashboard depicted in FIG. 5B where they can browse through different spending per category and compare their spending habits to the other clients that were grouped together with them.

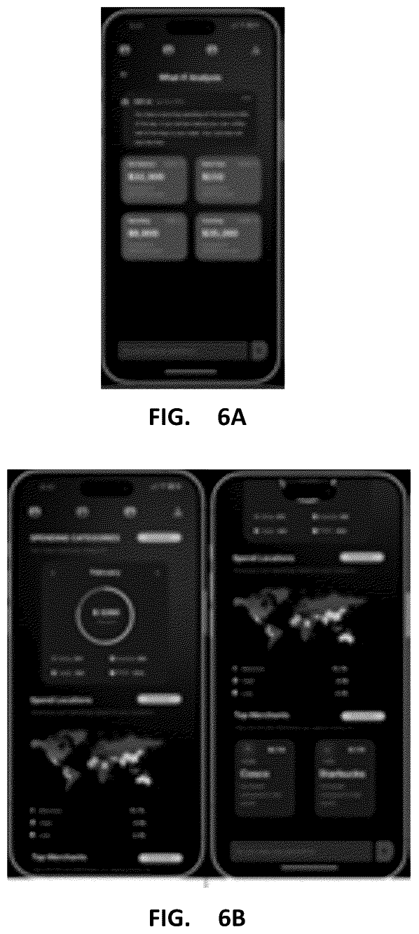

The user may navigate to an insights dashboard, such as that depicted in FIG. 6A that can display the generated what if scenario insights. The insights can highlight actions that could have been taken to alter their spending in order to better understand the effect such actions could have on their finances. The user may view their spending grouped into categories as depicted in FIG. 6B, which may be broken down by various details, such as industry categories, location, merchant, etc.

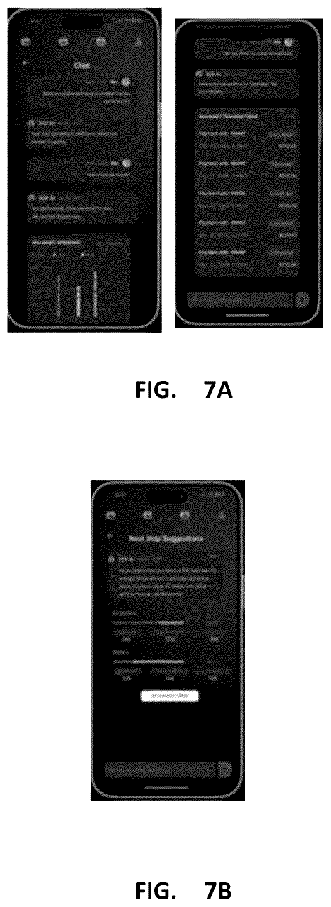

The user may navigate to next step suggestions dashboard depicted in FIG. 7A which provides possible suggested actions to taken based on the generated budget insights. These suggested actions may be acted on directly from the user interface or through their own future actions.

The enhanced statement user interface depicted in FIG. 7B may provide a chat interface that allows the user to query the backend chat functionality using natural language queries. The user is able to ask any questions regarding the insights or suggestions they see on the enhanced statement, or about their finances. Suggested queries or prompts may be automatically generated for the user or the user can ask their own questions.

The above has described various functionality for delivering an enhanced financial statement to clients. The enhanced statement can automatically analyze the user's financial transactions and provide details of the transactions to the user. The analysis may compare the user's financial transactions to their previous transactions, such as past month's spending or to the spending habits of their peers. Further, the enhanced statement functionality may generate various financial insights to the user providing possible actions the user may take to improve their finances. The financial analysis and insights may be queried by the user using a natural language chat interface to provide a convenient and easy to use interface providing useful information.

It will be appreciated by one of ordinary skill in the art that the system and components shown in FIGS. 1-7B may include components and/or steps not shown in the drawings. For simplicity and clarity of the illustration, elements in the figures are not necessarily to scale, are only schematic and are non-limiting of the elements and structures. It will be apparent to persons skilled in the art that a number of variations and modifications can be made without departing from the scope of the invention as defined in the claims.

Although certain components and steps have been described, it is contemplated that individually described components, as well as steps, may be combined together into fewer components or steps or the steps may be performed sequentially, non-sequentially or concurrently. One or more features, components, and/or elements may be described with reference to a particular embodiment. Such features, components and/or elements can be incorporated into and/or combined with other embodiments. Further, although described above as occurring in a particular order, one of ordinary skill in the art having regard to the current teachings will appreciate that the particular order of certain steps relative to other steps may be changed. Similarly, individual components or steps may be provided by a plurality of components or steps. One of ordinary skill in the art having regard to the current teachings will appreciate that the components and processes described herein may be provided by various combinations of software, firmware and/or hardware, other than the specific implementations described herein as illustrative examples.

The techniques of various embodiments may be implemented using software, hardware and/or a combination of software and hardware. Various embodiments are directed to apparatus, e.g. a node which may be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Numerous additional variations on the methods and apparatus of the various embodiments described above will be apparent to those skilled in the art in view of the above description. Such variations are to be considered within the scope of the current disclosure.

What is claimed is:

1. A system for use in generate a financial summary interface, the system comprising:
at least one processor for executing instructions; and
at least one memory storing instructions which when executed by one or more of the at least one processor configure the system to provide:
a data ingestion component for periodically ingesting financial transaction data and user profile data and storing in a contextual datastore;
a financial analysis component for generating at least one graphical representation of financial information associated with a user stored in the contextual datastore;
a large language model (LLM) interface for interfacing with an LLM;
a contextual chat component for responding to user chat queries using a large language model (LLM) and the financial information associated with a user stored in the contextual datastore; and
a financial insight component for generating one or more financial insights using the LLM and the financial information associated with the user stored in the contextual datastore.

2. The system of claim 1, wherein the contextual chat component uses a TXT to SQL LLM to generate a SQL query for use in retrieving contextual data from the financial information associated with the user stored in the contextual datastore for use in responding to the user query.

3. The system of claim 2, wherein the contextual chat component generates a prompt for the TXT to SQL LLM using the user query.

4. The system of claim 3, wherein the prompt is further generated using one or more of:
a table schema and feature description of financial information; and
a conversation history of the user's chat.

5. The system of claim 4, wherein the contextual chat component generates a response synthesis prompt based on the user query and the contextual data from the SQL query, the response synthesis prompt provided to the LLM to generate a response that includes response text and an indication of whether the response includes a visualization, and when the response includes a visualization the visualization data for use in generating the visualization.

6. The system of claim 1, wherein the financial insight component includes one or more context generators for retrieving contextual data for use in generating the financial insights.

7. The system of claim 6, wherein the context generators comprise one or more of:
a Financial Summary generator;
a Savings and Investments generator;
a Debts & Mortgages generator;
a Bank Fees generator;
a Top Spending Categories (Current Month) generator;
a Top Spending Categories (Last 6 Months) generator;
a Top Spending Merchants (Current Month) generator;
a Top Spending Merchants (Last 6 Months) generator;
a User Spending Summary generator; and
a Similar People Spending Summary generator.

8. The system of claim 1, wherein the financial insight component comprises a prompt generator to generate prompts to the LLM to generate the financial insights.

9. The system of claim 8, wherein the prompt generator generates the prompts using pre-planned structures for generating the prompts.

10. The system of claim 9, wherein the prompt generator uses the context generators to fetch necessary data for use in pre-defined LLM prompt templates.

11. A method for use in generating a financial summary interface, the method comprising:
periodically ingesting financial transaction data and user profile data and storing in a contextual datastore;
generating at least one graphical representation of financial information associated with a user stored in the contextual datastore;
receiving a user chat query and responding to the user chat query using a large language model (LLM) and the financial information associated with a user stored in the contextual datastore; and
generating one or more financial insights using the LLM and the financial information associated with the user stored in the contextual datastore.

12. The method of claim 11, wherein the responding to the user chat query uses a TXT to SQL LLM to generate a SQL query for use in retrieving contextual data from the financial information associated with the user stored in the contextual datastore for use in responding to the user query.

13. The method of claim 12, further comprising generating a prompt for the TXT to SQL LLM using the user query.

14. The method of claim 13, wherein the prompt is further generated using one or more of:
a table schema and feature description of financial information; and
a conversation history of the user's chat.

15. The method of claim 14, wherein the response to the user query is generated from a response synthesis prompt based on the user query and the contextual data from the SQL query, the response synthesis prompt provided to the LLM to generate a response that includes response text and an indication of whether the response includes a visualization, and when the response includes a visualization the visualization data for use in generating the visualization.

16. The method of claim 11, wherein the financial insights are generated using one or more context generators for retrieving contextual data for use in generating the financial insights.

17. The method of claim 16, wherein the context generators comprise one or more of:
a Financial Summary generator;
a Savings and Investments generator;
a Debts & Mortgages generator;
a Bank Fees generator;
a Top Spending Categories (Current Month) generator;
a Top Spending Categories (Last 6 Months) generator;
a Top Spending Merchants (Current Month) generator;
a Top Spending Merchants (Last 6 Months) generator;
a User Spending Summary generator; and
a Similar People Spending Summary generator.

18. The method of claim 16, wherein a prompt generator generates prompts to the LLM to generate the financial insights.

19. The method of claim 18, wherein the prompt generator generates the prompts using pre-planned structures for generating the prompts.

20. The method of claim 19, wherein the prompt generator uses the context generators to fetch necessary data for use in pre-defined LLM prompt templates.

21. A non-transitory computer readable medium storing instructions thereon, which when executed by a system configure the system to perform a method comprising:
periodically ingesting financial transaction data and user profile data and storing in a contextual datastore;
generating at least one graphical representation of financial information associated with a user stored in the contextual datastore;
receiving a user chat query and responding to the user chat query using a large language model (LLM) and the financial information associated with a user stored in the contextual datastore; and
generating one or more financial insights using the LLM and the financial information associated with the user stored in the contextual datastore.
